(19) United States
(12) Patent Application Publication
(10) Pub. No.: US 2004/0075656 A1
(43) Pub. Date: Apr. 22, 2004

(54) Method and apparatus for multi-dimensional shape representation via shock flows

(76) Inventors: Benjamin B. Kimia, Providence, RI (US); Frederic Fol-Leymarie, Laval (CA); Huseyin Tek, Princeton, NJ (US)

Correspondence Address: David E. Huang, Esq., CHAPIN & HUANG, L.L.C., Westborough Office Park, 1700 West Park Drive, Westborough, MA, 01581, US

(21) Appl. No.: 10/677,720

(22) Filed: Oct. 2, 2003

Related U.S. Application Data
(60) Provisional application No. 60/419,563, filed on Oct. 18, 2002.

(51) Int. Cl. G06T 17/00

(52) U.S. Cl. 345/420

(57) ABSTRACT

A method and apparatus for representing a multi-dimensional shape includes deriving a shock scaffold from an unorganized point cloud. The shock scaffold is derived by shocks recovered from collisions of logical wavefronts. The logical wavefronts are initialized from selected points in the unorganized point cloud. Shocks hold topology information including speed accelerations and direction from boundaries of the multi-dimensional shape. The shocks recovered from wavefront collisions define shock sheets of the multi-dimensional shape. Representative shock points of the shock sheets are paired to find shock curve representatives as another set of special shock points. The latter are also paired to find shock vertices and the remaining nodes and links defining the full shock scaffold representation of the multi-dimensional shape.

### CROSS REFERENCE TO RELATED APPLICATIONS

This application claims the benefit of priority to U.S. Provisional Application Ser. No. 60/419,563 filed Oct. 18, 2002 and entitled “Three-Dimensional Shape Representation Via Shock Flows,” the teachings of which are hereby incorporated by reference in their entirety.

### STATEMENT OF GOVERNMENT INTEREST

This invention was partially funded by the Government under grants from the National Science Foundation, Contract no. IRI-9700497 and Contract no. IRI-0083231. The Government has certain rights in portions of the invention.

### BACKGROUND OF THE INVENTION

Understanding an object's shape in two or three dimensions is useful in many applications including pattern analysis and machine intelligence. For example, animations typically employ shape structures upon which forces and feedback are exercised. Machine tooling, computer graphics, biomedical imaging, and architecture simulators are further examples where the understanding and efficient representation of shape are important.

Examples of traditional shape models are voxel (that is, volume pixel) or trianglebased rendering engines. Other conventional shape models include implicit polynomials, generalized cylinders, superquadrics and splines. Another conventional model is the Medial Axis (MA), the locus of centers of maximal balls in contact with input data where each item of input data is referred to as a generator. Each locus has an associated radius value giving the distance from the MA to the generators of that locus. A complementary and equivalent definition of the MA is the model that is generated when waves are propagated from generators and quenched at loci which trace the MA. In general, the MA has a branching structure related to the object's topology and geometry. The MA typically encodes a time of formation of each MA point by carrying relative width properties via a radius function. The advantages of the MA include that the MA is an intuitive representation of elongated objects such as an anthropomorphic form. Further, an MA can generally encode the blobbyness of a shape, that is, the varying width of a form because the MA has the radius function. Still further, the MA typically makes explicit object contour features such as curvature extrema and ridges through the branch “tips” of the MA model. The MA describes both the interior and exterior regions of space and segments these regions as a function of their relative closeness to the object's outline. The MA can partition a shape by combining width and elongation properties, where, for example, different MA branches represent different object parts. In general, the MA has a hierarchy of scales in that its spatial and time-like properties enable smaller features to be distinguished from larger features and the features can be ranked accordingly. Another advantage of the MA is that it provides a fairly complete representation. That is, generally, the entire object and its details are represented, from small bumps along a boundary to large engulfings of main parts. The MA also employs some dimensional reduction, that is, it maps an object and the space that the object occupies into a thin set.

There are a number of conventional methods of creating an MA model of an object, also called extracting MA symmetries in 3D. A first conventional method of creating an MA is by thinning an object by iteratively peeling off discrete layers of the object until an approximation of MA loci remain. A second conventional method of creating an MA involves following ridges on distance maps. A third conventional method of creating an MA uses “grass-fire” transforms in which “fires” are initiated at boundary loci. The fire wavefronts meet and are quenched. The quenching wavefronts are the MA loci. A fourth conventional method of creating an MA is to take families of primitive shapes which can retro-fit to object data. A fifth conventional method of creating an MA is based on using a Voronoi diagram to approximate the MA. A sixth conventional method of creating an MA involves doing full bisector computations followed by trimming operations to define generalized descriptions of the MA.

In sum, the MA is a well-developed model of multi-dimensional shapes having a

### SUMMARY OF THE INVENTION

Unfortunately, there are shortcomings to the conventional methods and apparatus for representing multi-dimensional objects. Conventional multi-dimensional representation technology does not provide a stable, full representation combined with fast processing time and data compression. Conventional object representation techniques including the MA do not provide robustness against perturbations, partial occlusions and articulated movements, choice of metric for matching applications, categorization sensitivity, i.e. low-cost matching within a class of similar objects (such as trees) vs. high cost matching across classes (such as trees vs. airplanes). MAs for similar objects may not be unique and therefore object matching of similar object using MAs is unreliable. Further, the MA is unstable in certain situations for example, for small protrusions. The MA typically generates a spurious branch with the introduction of a small protrusion. The MA datasets tend to be large which slows down processing time and creates a problem for storing MAs. It is desirable to have a method and apparatus for obtaining as exact a multi-dimensional representation of an object as possible with a minimum of computational limitations.

Representation of multi-dimensional shapes is accomplished by embodiments of the present invention including two computational schemes for a shock scaffold. The shock scaffold provides a representation of a multi-dimensional object by linking special points of the object called shocks. The shock scaffold is a directed graph that incorporates the notion of flow through the links to provide complete information about the object shape. The first computational scheme is a Lagrangian scheme and does not have a reference grid. The second computational scheme is Eulerian and employs a reference grid. Both computational schemes are capable of finding shocks in unorganized points clouds, such as sample points generated by laser scanning of the object. Both computational schemes involve generating wavefronts from shocks to determine the organization of the shape of the object.

The first computational scheme for obtaining a shock scaffold is the Lagrangian computational scheme which does not require a fixed grid. In this method, in initial set of sources for the flow along the MA is identified. These are sources for MA sheets, that is, pairing two distinct outline pieces. The sources are then paired to identify sources of flow for MA curves. The MA curves are then paired to identify MA vertices where the curves implicitly intersect. Some of the sources of flow for curves and some of the vertices are relays for the flow, that is, loci where the entrant flows collide and are reinitiated, in different directions. The new flows are tracked and the system looks for new intercepts (pairings) until all flows terminate at sinks, or at infinity, or at the spatial limits of a fixed zone where all computations are restricted to take place.

A second computational scheme for obtaining a shock scaffold is the Eulerian grid. Shocks are discovered by the collision of waves propagated in a tessellated space which takes the form of a rigid uniformly connected grid. An explicit search is performed through the embedding space. Essentially, the propagation carries only those samples to the grid node where a pairing must occur, thus explicitly limiting the number of false pairings. The computation complexity of the Eulerian method is essentially dependent on the number of grid nodes, or cells, used to tessellate space.

The present invention operates to provide an object model even where the initial data is a collection of unorganized points or polygonal patches in space, e.g., unorganized point clouds. These are arbitrary sets of points in three-dimensional space for which no initial connectivity information is known. Ability to operate using only point clouds as input has applications because objects conventionally are sampled by points. Many data collection sensors, such as, active sensing by laser scanners, produce point samplings. Another advantage in capability of analyzing points clouds is that connectivity data, where it is provided, can be unreliable or incomplete. The ability to operate in an environment where some links between points are incorrect and where some needed links are missing makes the system of the present invention more reliable and functional than conventional systems.

The system is also capable of modeling objects where the input data is surface patches also rather than simply points. The system according to the present invention is therefore able to use data stored as surface meshes. The surface patches can be unorganized polygonal clouds.

More specifically, embodiments of the invention provide methods and apparatus that receives as input unorganized points in space that are sampled from the surface of an object and derives a shock scaffold representation of the object. The method forms a plurality of shocks based on the unorganized point input where the shocks are formed at collisions of a plurality of wavefronts initiated from the plurality of shocks. The shocks hold topology information about the surface of the object including flow speed and direction from the boundary of the object. The method then generates the whole shock scaffold from the plurality of shocks. The object's surface can be reconstructed from data in the shock scaffold representation.

In another embodiment of the invention, the step of forming shocks from the input further comprises the step of defining a plurality of clusters where the input data is distributed among the defined clusters. The method then examines each cluster to determine pairs of generators by applying visibility constraints to the generators. A shock candidate is generated from each pair of generators. The method then validates the shock candidates by examining the contact sphere of each candidate. If no other generators other than the generator pair are in the contact sphere, then the shock candidate is a valid shock. If there are other generators in the contact sphere, then the shock candidate is not valid. In this step, shocks defining shock sheets are computed. These types of shocks are used to find shock curves which are in turn used to find shock vertices of the shock scaffold. In another embodiment of the invention, clusters of generators are treated as meta-generators. At the cluster scale, a first cluster acts on a second cluster similarly to the way a first generator acts on a second generator in a generator pair. The examination of cluster pairs enables the system of the invention to rapidly rule out sections of space from being searched for other cluster pairs. At the generator scale, the content of a cluster is considered by pairing generators within a cluster. This method of fine-scale generator pair selection may be effectively used in dynamic data acquisition systems because the method computes constrains for points in clusters as the points are acquired, as though from a dynamic data acquisition system.

In another embodiment of the invention, the step of computing shock candidates further comprises defining a fixed multi-dimensional grid in space around the plurality of points. The fixed grid acts as a reference for wavefront propagation from each of the plurality of points. The method initiates logical wavefronts by initiating cellular automata along the grid from chambers including at least one of the plurality of points. The cellular automata collide. The method detects a shock at each collision. In this alternative method of finding shock candidates, the fixed grid provides a reference and an initial approximation of organization of the input data. The use of a fixed grid permits the method to avoid validating shocks in an exhaustive manner in order to ensure the associated ball is maximal (i.e. empty of other generators).

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views.

FIG. 1 is a block diagram of a computer system including a shock scaffold engine according to principles of the invention;

FIG. 2 is a sketch of a plurality of sampled points of a box-shaped object;

FIG. 3 is a shock scaffold generated from the sampled points of FIG. 2;

FIG. 4 is a diagram of a plurality of objects and the medial axis representations of each of the plurality objects and shock structures of each of the plurality of objects;

FIG. 5 is a diagram of a two-dimensional object illustrating shock generation;

FIG. 6A is a medial axis representation of a three-dimensional object;

FIG. 6B is a shock hypergraph representation of a three-dimensional object;

FIG. 6C is an augmented shock scaffold representation of a three-dimensional object;

FIG. 6D is a shock scaffold representation of a three-dimensional object;

FIG. 6E is a reduced shock scaffold representation of a three-dimensional object;

FIG. 6F is a topological scaffold representation of a three-dimensional object;

FIG. 7 is a side view diagram of contact spheres intersecting boundaries giving rise to types of shocks;

FIG. 8A is a diagram of an overview of shock scaffold computation using a first computational method according to principles of the present invention;

FIG. 8B is a diagram of an overview of shock scaffold computation using a second computational method according to principles of the invention;

FIG. 9 is a flow chart of the general operation of the first computational method for deriving a shock scaffold according to principles of the invention;

FIG. 10 is a flow chart of the operation of shock candidate computation of the first computational method of FIG. 9;

FIG. 11 is a flow chart of the operation of validating shock candidates computed using the method of FIG. 10;

FIG. 12 is a diagram illustrating visibility of generators according to principles of the invention;

FIG. 13 is a diagram illustrating paired generators and the associated dead zone and visible zone of the paired generators according to principles of the invention;

FIG. 14A is a diagram illustrating a one-dimensional beam according to principles of the invention;

FIG. 14B is a diagram illustrating a two-dimensional beam according to principles of the invention;

FIG. 14C is a diagram illustrating a three-dimensional beam according to principles of the invention;

FIG. 15 is a two dimensional grid showing beam propagation using the Eulerian computational method of deriving a shock scaffold of the present invention;

FIG. 16 is a flow chart of the basic operation of the Eulerian computational method for deriving a shock scaffold of the present invention;

FIG. 17A is a diagram of a grid chamber 920 illustrating passage of the first type of Lagrangian cellular automata, the 2D Lagrangian automata for shock sheets according to principles of the invention;

FIG. 17B is a diagram of a grid chamber 950 illustrating passage of the second type of Lagrangian cellular automata, the 1D Lagrangian automata for shock curves according to principles of the invention;

FIG. 18 is flow chart of the operation of the Lagrangian automata in finding shock sheets and shock curves in deriving a shock scaffold according to principles of the invention;

FIG. 19A is an example of a Voronoi diagram of a set of point generators which is suitable for use with the computational methods of the present invention;

FIG. 19B is a medial axis for the set of point generators of FIG. 19A; and

FIG. 19C is the shock scaffold for the point generators of FIG. 19A.

### DETAILED DESCRIPTION

### Introduction

Representation of two and three-dimensional shapes is accomplished by embodiments of the present invention including two computational schemes for a shock scaffold. The shock scaffold provides a representation of a multidimensional object by linking special points of the object called shocks. The shock scaffold is a directed graph that incorporates the notion of flow through the links to provide complete information about the object shape. Flow is the projection of the gradient of the radius function associated with the medial axis (MA) maximal contact balls. This projection is taken onto the tangent space to MA sheets or curves. The projection creates a vector field along the MA sheets and curves. Certain singularities of this induced vector field are then retained to constitute the nodes of the shock scaffold. The connectivity of the singularities via the flow creates the directed links of the scaffold. In short, the shock scaffold enables information from an N-dimensional space to be mapped to a graph while the MA maps the information to a set of N-1-dimensional sets, e.g. surfaces in three-dimensional space.

The first computational scheme is a Lagrangian scheme and does not have a reference grid. The second computational scheme is Eulerian and employs a reference grid. Both computational schemes are capable of finding shocks in unorganized points clouds, such as sample points generated by laser scanning of the object. Both computational schemes involve generating wavefronts from shocks to determine the organization of the shape of the object.

The surface of an object is extracted from a shock scaffold by ranking selected MA curves on the basis of their associated local surface interpolant. Each MA curve is generated from three associated input points, and the local surface interpolant associated with the MA curve is defined as the triangle interpolating the three points. Once the surface is recovered, the shock scaffold is segregated into two subgraphs, one linked to the sampled surface and other lying on either side of the recovered surface. The non-surface sub-graph is connected in larger surface and curve structures resulting in an approximation of large MA sheets and curves lying deeper inside and out of the originally sampled object. In the case where the goal is surface meshing alone, the calculation of the scaffold may be ended at the surface interpolant. Once the MA curves providing the surface mesh are found, the remaining shock nodes need not be calculated if the goal of calculation was only the surface.

Representation of Shape

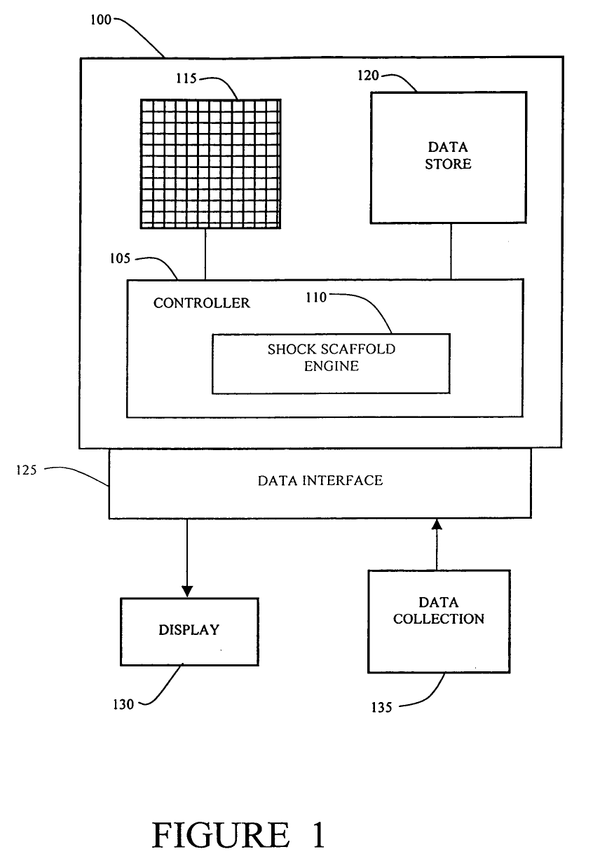

FIG. 1 is a block diagram of a computer system suitable for use by the present invention. The computer system 100 includes a controller 105 having a shock scaffold engine 110, a memory 115, a data store 120, and a data interface 125. The computer system 100 further includes a display 130 and a data collection system 135.

The shock scaffold engine 110 is part of the controller 105 and acts in conjunction with the memory 115 and data store 120 in the computer system 110 to compute shock scaffolds from input data about an object such as sampled points from a laser scanner. In this embodiment, the sample points are received from the data collection system 135 connected to the computer system 100 through the data interface 125. The data collection system 135 may, for example, be a laser scanning system to scan object surfaces. The shock scaffold is a data structure stored in the data store 120 and can also be visually displayed on the display system 130 connected to the computer system 100.

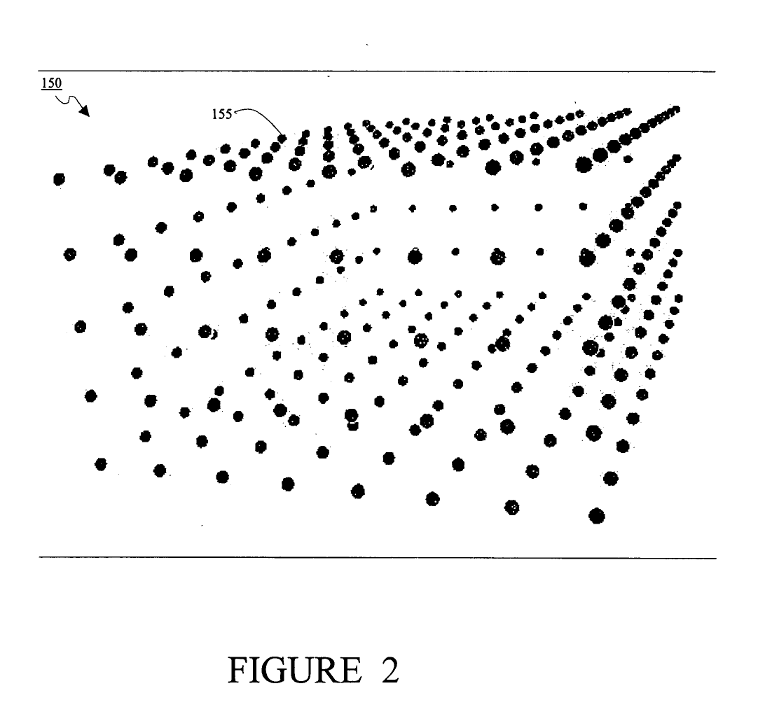

FIG. 2 shows a set of sampled points 155 which is suitable for use by the computer system 100. By way of example only, the sampled points 155 are points from a surface of a box-shaped object 150, and sampled points 155 from other shapes are suitable for use by the computer system 100 as well. As will be explained in further detail shortly, the shock scaffold engine 110 of the computer system 100 is capable of obtaining the sampled points 155 through the data collection system 135, generating a shock scaffold representing the box-shaped object 150 from the sampled points 155, and storing the shock scaffold in the data store 120 in an efficient amount of memory space for subsequent use (e.g., for rendering images of the box-shaped object 150 on the display 130 based on the shock scaffold when the shock scaffold is stored in the data store 120, also see FIG. 1).

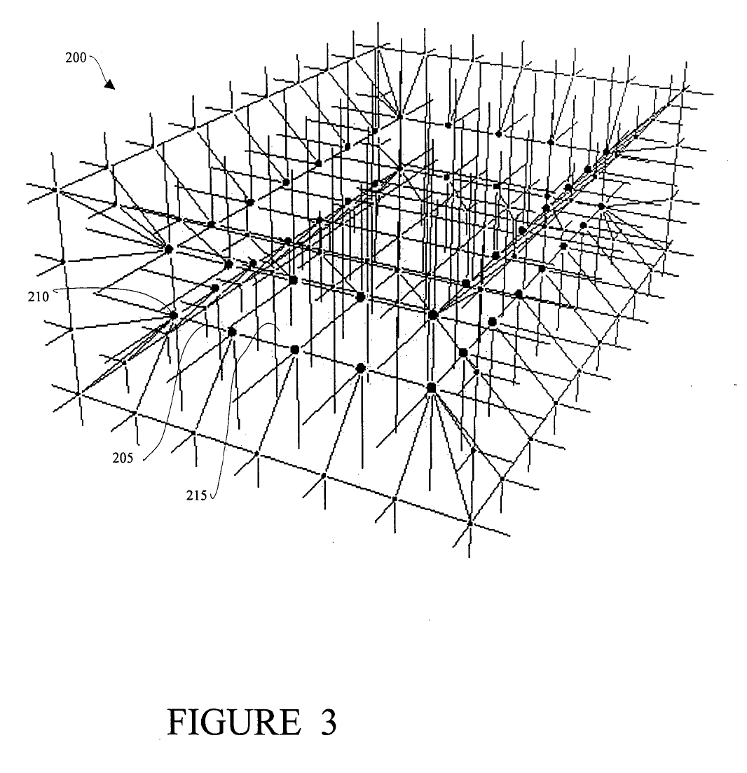

Even though the sampled points 155 may be recognizable to the human eye as being from the surface of the box-shaped object 150, it should be understood that there is no linking information included with the sampled points 115. Accordingly, conventional computers generally view the sampled points 155 as an unorganized point cloud, and are unable to classify the sampled points 155 as being from the box-shaped object 150. In contrast to such conventional computers, the computer system 100 is capable of analyzing the sampled points 155 to recognize the surface of the box-shaped object 150, as well as performing similar operations on more complex data. As a result, the computer system 100 is well-suited for a variety of applications in which a set of sampled points but no linking information is available (e.g., medical imaging, archeology, etc.). No assumption is made on the input points (which may be degenerate configurations) and the sampling methods (which need not be uniform).” While the box-shaped object 150 shown in FIG. 3 is a simple shape, more complex objects such as a human brain or a pot shard, can be represented multi-dimensionally including the object's edges and surface details.

FIG. 3 shows a shock scaffold 200 generated by the computer system 100 from the sample points 155 of FIG. 2. In general, each shock scaffold 200 generated by the computer system 100 includes a set of shock curves 205 and a set of shock nodes 210. The location of the shock nodes 210 within the shock scaffold 200 is with respect to the object's boundary, in this case, the boundary of the box-shaped object 150. A shock node 210 is a point augmented with attributes about the flow. A shock curve 205 is a link between shocks. A sheet 215 is defined by a plurality of shock curves 205 defining a loop implicitly defining a boundary for the sheet. The sheet 215 therefore also connects a plurality of shock nodes 210. Together, the shock nodes 210, shock curves 205 and sheets 215 provide a full representation of the box-shaped object 150. The flow in a shock scaffold is induced by the gradient of the radius function of the shock scaffold.

It should be understood that the shock scaffold 200 is a data structure capable of being represented in the computer memory 115 and stored as data in the data store 120 as well as a visual representation of a multi-dimensional object capable of being displayed on a visual display 130. The shock nodes 210, shock curves 205 and sheets 215 are described herein as physical entities but it should be understood that the shock nodes 210, shock curves 205 and sheets 215 are signals generated in the computer system 100. While the shocks nodes 210 are the main data upon which the scaffold is built, the operation of the invention will be explained in terms of how their representations interact in order to facilitate understanding of the invention.

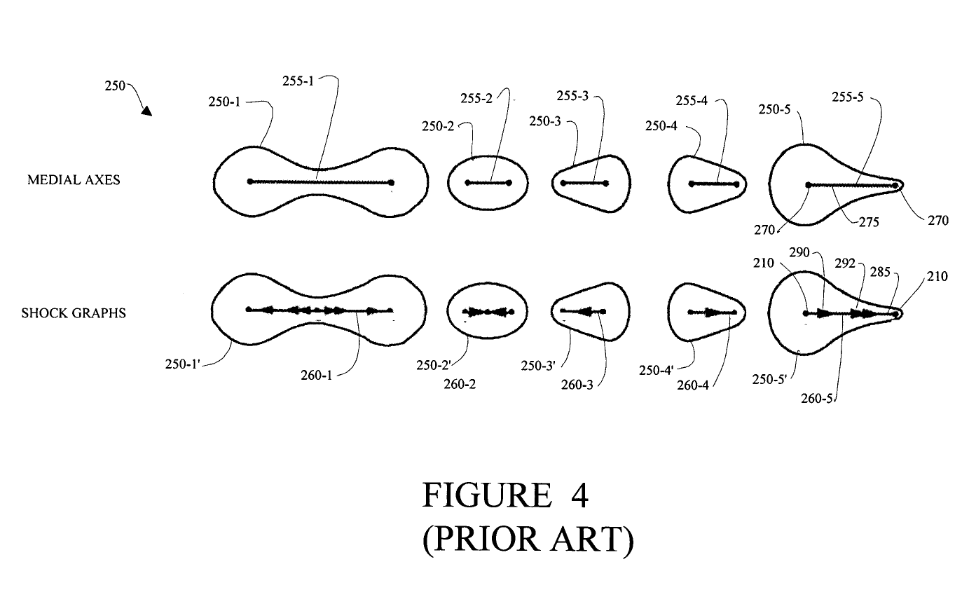

FIG. 4 is presented to illustrate differences between the MA and the shock scaffold and also to illustrate advantages of representing multi-dimensional objects using the shock scaffold rather than the MA. FIG. 4 shows a plurality of objects 250-1, 250-1′, 250-2, 250-2′, 250-3, 250-3′, 250-4, 250-4′, 250-5, 250-5′ (collectivel numbered 250). Also shown are the medial axis representations 255-1, 255-2, 255-3, 255-4, 255-5 (collectively numbered 255) of the objects 250 and the shock graph representations 260-1, 260-2, 260-3, 260-4, 260-5 (collectively numbered 260) of the objects 250. A shock graph is a shock scaffold in two dimensions. The objects 250 and representations 255, 260 in FIG. 4 are presented to illustrate the concept of flow in a shock structure representation of an object and further to illustrate the distinction of shock scaffold from the medial axis.

The objects 250-1′, 250-2′, 250-3′, 250-4′, and 250-5′ contain their shock scaffold representations 260. In contrast to the MA representations, each object 250 has an essentially different shock graph representation 260 having two or more shock node 210 connected by curves 285. The shock graph representations 260 incorporate the notion of flow indicated by arrows 290, 292. The arrows 290, 292 indicate the direction of the flow at the shocks 280 and through the curves 285. Flow has both direction and speed.

The direction of the shock node 210 is the direction of the flow at the point location of the shock node 210. Flow is directed from, through and to shocks in the direction of increasing radii values from the boundaries of the object. Speed is indicated in the shock structure representations 260 by the number of arrows 290. A single arrow 290 indicates slower speed and double arrows 292 indicate faster speed and possibly other attributes, such as accelerations. This illustrates an advantage of shock scaffold representation. The shock structure representations 260 provide a model of the objects 250 that distinguishes one object from another through the incorporation of flow.

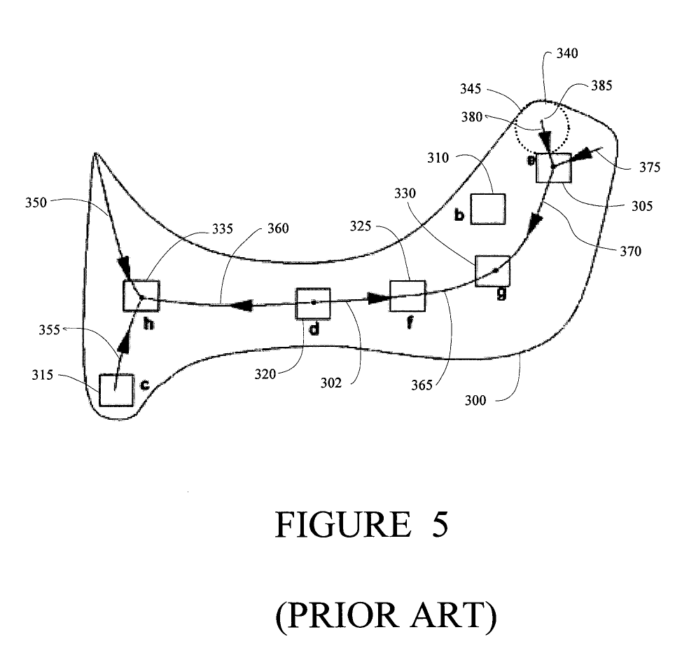

FIG. 5 is presented to illustrate the relationship between shock nodes 210 (FIG. 3) and flow (represented by arrows) and surface boundaries of an object. The object 300 shown in FIG. 5 is a two-dimensional object. Two dimensions are used for simplicity and clarity. In general, shock nodes 210 and flow have equivalent relationships to object boundaries in three dimensions. FIG. 5 also illustrates how shock nodes 210 are found from surface boundaries in order to better understand how the shock scaffold engine 110, using the methods of the present invention, computes shock nodes 210 from sampled points of the object's surface.

When an object's surface is already known, the computer system 100 can readily generate a shock scaffold 200 representing the object's surface. Any place of an extremum of shape has a point that represents the center of the curve along the boundary at that place. One way of deriving the curve center 385, which is one type of shock, is by finding the center of an osculating disc 340 at the boundary curve at a place of the extremum 345. Depending on the orientation of the boundary curve, the osculating disc 340 may touch the boundary either on the inside or the outside of the object. The osculating disc 340 is also called a contact disc. The three-dimensional equivalent of the osculating disc is the osculating sphere, also called the contact sphere. A shock structure 302 arises from wave propagation from the boundaries of the object 300. As before flow is induced by the gradient of the radius function associated with the contact discs.

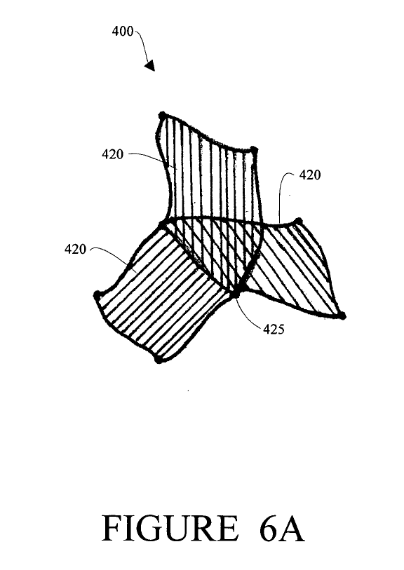

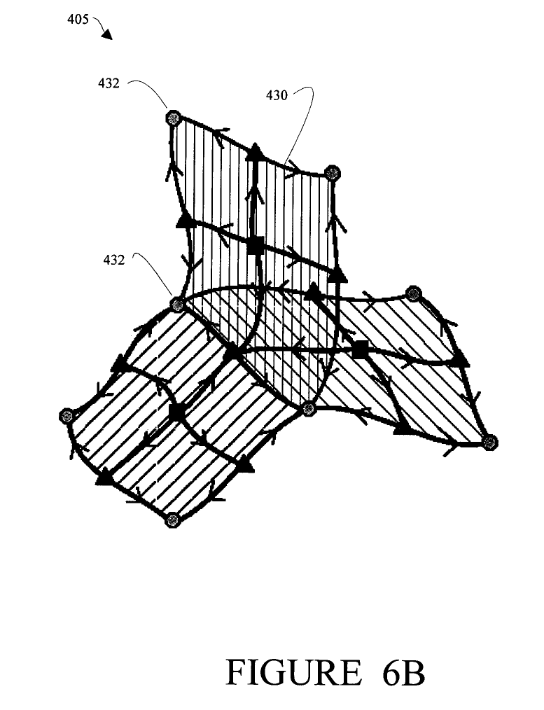

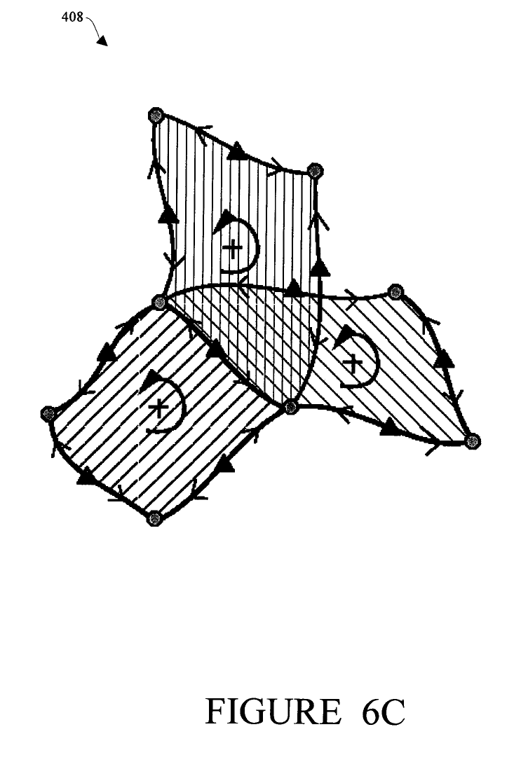

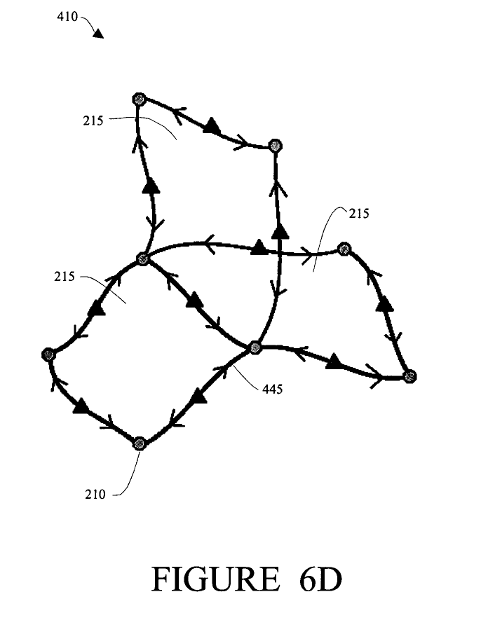

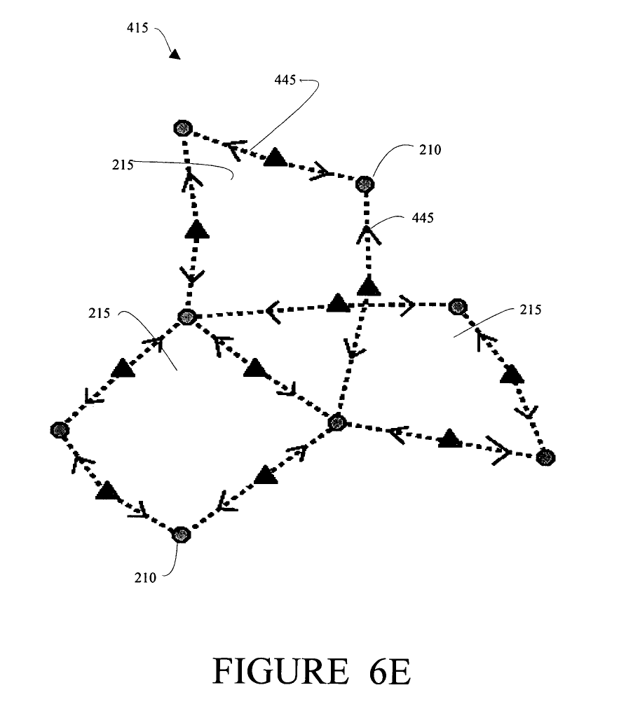

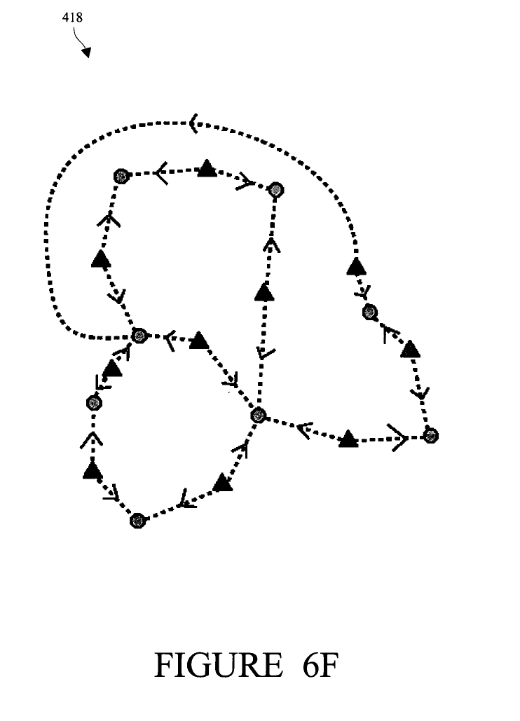

The two-dimensional object 300 has a plurality of points 305, 310, 315, 320, 325, 330, 335 inside the object 300. Also, inside the two-dimensional object 300 are a plurality of graph segments 350, 355, 360, 365, 370, 375, 380 connecting some of the points 305, 315, 320, 325, 330, 335 to form a shock graph 302. The points 305, 310, 315, 320, 325, 330, 335 illustrate the various points within the object that are either shock locations or that do not form shocks. The points 305, 310, 315, 320, 325, 330, 335 are provided for illustration purposes and are not considered to be comprehensive as there are both more points that are shock locations and points that are locations where no shocks are formed. There are no shocks at point 310 where no contact sphere can be maximal. There is an initial shock at point 315, a point corresponding to a curvature extremum of the boundary. There is a shock at point 305, a junction of two in-coming flows which is also called a shock sink. There is a shock at point 320 where there are two outgoing flows also called a shock source. There is a shock at point 325 where the flow is monotonic, or regular, which also defines a shock segment, also called a shock relay. There is a shock at point 330 where a pair of branches terminate. There is another shock at 335 where 3 branches terminate. The shock sinks, sources and relays each provide topology information about the two-dimensional object 300. In three dimensions, the shock scaffold has flow along sheets and curves and through the vertices of the shock scaffold as seen below in FIG. 6. The shock structure 302 is formed by connecting the shocks 305, 315, 320, 325, 330, 335 and the graph segments 350, 355, 360, 365, 370, 375, 380 which, here, are shock curves. Where the surface of the object is not known, and the input is an unorganized point cloud, the computer system 100 needs to use other methods to derive a shock scaffold, for example the methods of the present invention.

FIG. 6 illustrates another advantage of the shock scaffold over the MA as a representation of multi-dimensional objects beyond the advantages discussed with regard to FIG. 4. FIG. 6 also further defines and describes the shock scaffold with respect to the MA. The shock scaffold provides a complete representation of a multi-dimensional object while providing greater data compression than the MA.

FIG. 6 shows several semi local representation models for representing multidimensional objects. FIG. 6A shows a medial axis representation 400, or MA; FIG. 6B shows a shock hypergraph 405; FIG. 6C shows an augmented shock scaffold 410; FIG. 6D shows a shock scaffold 415; FIG. 6E shows a reduced shock scaffold; and FIG. 6F shows a topological scaffold.

The medial axis representation 400, or MA, of FIG. 6A is formed by three medial sheets 420 intersecting into a medial curve 425. While the MA 400 is a full representation of a multi-dimensional shape, the MA 400 uses a larger amount of data to make the full representation than does the shock scaffold 410 because the medial curves and medial sheets, as well as the nodes of the MA are explicitly stored.

As shown in FIG. 6B, the shock hypergraph 405 is an intermediate representation between the MA 400 and a shock scaffold 410. The shock hypergraph 405 is derived from contact spheres and flow as described above in two dimensions with respect to FIG. 5. In a shock hypergraph 405, shock nodes 432 are identified and connected by directed links 430. The points represented by triangles are shock nodes for shock curves, e.g. a shock source for a curve, as in an A₁³-2. The small squares represent shock nodes for shock sheets (e.g. a shock source for a sheet, as in an A₁³-2). The shock hypergraph is a complete representation of a shape, but the shock hypergraph has some redundancy. The shock hypergraph makes explicit the shock nodes and their connectivity in the interior of sheets and curves.

As shown in FIG. 6C, the augmented shock scaffold 408 is a representation where shock nodes along curves are connected by directed links. The triangles represent shock nodes for shock curves. The cycle order of the hyperlinks is indicated by a counterclockwise arrow in each sheet. The augmented shock scaffold explicitly traces the interiors of shock sheets, but without shock nodes for these sheets.

As shown in FIG. 6D, the shock scaffold 410 is a shock hypergraph without the redundancy. The shock scaffold 410 has three intersecting shock sheets 215. Each shock sheet 215 is defined by shock nodes 210, some of the shock nodes 210 forming boundaries 445 to the sheets 215. The circles represent shock vertices. The triangles represent shock nodes for shock curves. The interiors of the shock sheets 215 are implicitly defined by the shocks 210 and boundaries 445. Another definition of a shock scaffold, therefore, is a hierarchical data organization where either shock sheets 215 or shock sheets 215 and curves are represented by their boundaries 445. Because the shock sheets 215 are implicit, the shock scaffold 410 provides an object representation with greater data compression than the MA 400.

As shown in FIG. 6E, in the reduced shock scaffold 415, the shock sheets 215 and boundaries 445 (which are also shock curves) are implicitly defined by the shock nodes 210. A reduced shock scaffold 415 provides an object representation using a minimal set of data because both shock sheets 215 and shock curves are implicit. In some instances, the reduced shock scaffold 415 does not provide a complete representation of an object.

As shown in FIG. 6F, in the topological scaffold 418, only the topology of the graph structure of the shock scaffold is retained. The topological scaffold 418 is a set of nodes and links without geometry. The topological scaffold is useful for defining larger or coarser classes of objects and for applications where only the connectivity (i.e., the topology) is important.

There are different types of shock nodes 210 and it is important to understand some of the types of shocks as the computational methods presented herein generate a shock scaffold 200 by identifying shock structures within unorganized input data. As discussed above with regard to FIG. 5, the center of a maximal disc (2D) or maximal sphere (3D) is a shock nodes 210. The shock nodes 210 has a type according to the type of contact of the maximal sphere with the object surface and its flow type. The computational methods of the present invention generate a shock scaffold 200 from input data about an object's surface by identifying shock structures in the input data as defined by particular shocks

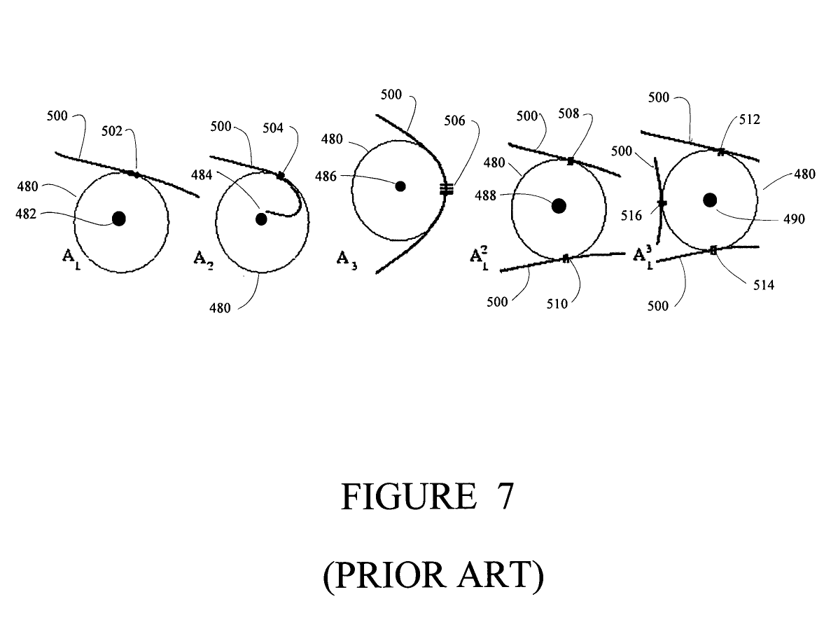

FIG. 7 is presented to describe some of the types of shock nodes 210 and also to present nomenclature for the various types of shocks. FIG. 7 is a side view of contact spheres 480 giving rise to some types of shocks 482, 484, 486, 488 and 490. Shocks are first classified according to the number of contact boundary points, and according to the degree of contact A shock Aₖⁿ has a contact sphere touching a boundary at n points, each point having a k+1 degree of contact.

Table 1 shows a classification of the 18 possible shock points based on contact with spheres, Aₖⁿ, and flow type. The later flow typology is explained next.

TABLE 1

| Shock Flow | 1 | 2 | 3 | 4 |
|---|---|---|---|---|
| Sheet | A₁² − 1 | A₁² − 2 | A₁² − 3 | A₁² − 4 |
| Rib | A₃ − 1 | A₃ − 2 | A₃ − 3 | A₃ − 4 |
| Axis | A₁³ − 1 | A₁³ − 2 | A₁³ − 3 | A₁³ − 4 |
| Rib end | — | A₁A₃ − 2 | A₁A₃ − 3 | A₁A₃ − 4 |
| Axis end | — | A₁⁴ − 2 | A₁⁴ − 3 | A₁⁴ − 4 |

First flow typology along sheets and curves is considered. A regular shock, also referred to as a 1^{st} order shock is a shock at which flow goes through smoothly: (i) along a sheet: A₁²-1; (ii) along a curve: A₁³-1, A₃-1. A shock source, also referred to as a 2^{nd} order shock is a shock which initiates flow: (i) on a sheet: A₁²⁻2; (ii) on a curve: A₁³-2, A₃-2. A shock relay, also referred to as a 3^{rd} order shock is a shock which is both a source and a sink for the flow: (i) for a sheet: A₁²-3; (ii) for a curve: A₁³⁻3, A₃-3. A shock sink, also referred to as a 4^{th} order shock is a shock at which flow type terminates: (i) for a sheet: A₁²-4; (ii) for a curve: A₁³-4, A₃-4. Second, the typology of flow at vertices is based on the number of inward flows, i.e., along shock curves intersecting at the vertex.

Returning to FIG. 7, for shock 482, the contact sphere 480 touches a boundary 500 of an object at one contact point 502. The degree of contact k=1, so shock 482 is classified as an A₁ type of shock. Where n=1, the number of contact points not shown by convention. For shock 484, the contact sphere 480 touches the boundary at one contact point 504 with a degree of contact k=2. Accordingly, shock 484 is classified as an A₂ type of shock. For shock 486, the contact sphere 480 touches the boundary 500 at one contact point 506 with a degree of contact k=3. Accordingly, shock 486 is classified as an A₃ type of shock. For shock 488, the contact sphere 480 touches the boundary 500 at two contact points 508, 510 with a degree of contact k=1. Accordingly shock 488 is classified as an A₁² type of shock. Sets of A₁² shock define the interior of sheets within the shock scaffold Finally, for shock 490, the contact sphere 480 touches the boundary 500 at three contact points 512, 514, 516 with a degree of contact k=1. Accordingly, shock 490 is classified as an A₁³ type of shock.

Only odd orders of contacts correspond to maximal contact spheres (i.e. where the surface outline does not cross over the boundary of the maximal contact sphere). Once the contact typology is defined, the associated radius flow typology is determined. That is, the gradient of the radii of the spheres is projected in the tangent space of the medial sheets and curves. The shock scaffold nodes are identified from the singularities of the induced vector field. This yields the sources for sheets and curves, relays for sheets, curves and at vertices, and sinks for sheets, curves and at vertices. All vertices, being points, are used as nodes of the scaffold. Three types of vertices are distinguished from the number of outward flows at the particular vertex. Referring to Table 1, the first column (regular shock flow) is made implicit in the scaffold. The corresponding MA points represent the interior of sheets and curves where no singularities of the flow occur. Degenerate cases, where an entire MA sheet patch (curve or surface), or an entire MA curve segment is produced at once, are labeled as special types of relays (numbered “3” in analogy to other relays) and represented by a single arbitrary point along their trace. The singularities of the flow being isolated nodes in space are then connected by following the flow direction to create the directed graph structure that is the basis of the shock scaffold hierarchy.

Where the generators are points or spheres, many shock types cannot occur. This simplifies the typology of shocks to eight shocks of the sixteen shocks of Table 1. These eight possible shock points based on contact with spheres, Aₖⁿ, and flow type, when generators are points only, are shown in Table 2. When studying only points and spheres, those shocks occurring only due to ridges can be eliminated from consideration. Accordingly, those shocks in the “rib” and “rib end” rows of Table 1 are eliminated from consideration in this case. Further, the shock scaffold in this case includes the Voronoi diagram as a special case. The system of the present invention therefore permits the efficient computation of a three dimensional Voronoi diagram as a by-product, as will be further explained below.

TABLE 2

| Shock Flow | 1 | 2 | 3 | 4 |
|---|---|---|---|---|
| Sheet | A₁² − 1 | A₁² − 2 | — | — |
| Axis | A₁³ − 1 | A₁³ − 2 | A₁³ − 3 | — |
| Axis end | — | A₁⁴ − 2 | A₁⁴ − 3 | A₁⁴ − 4 |

Computational Aspects

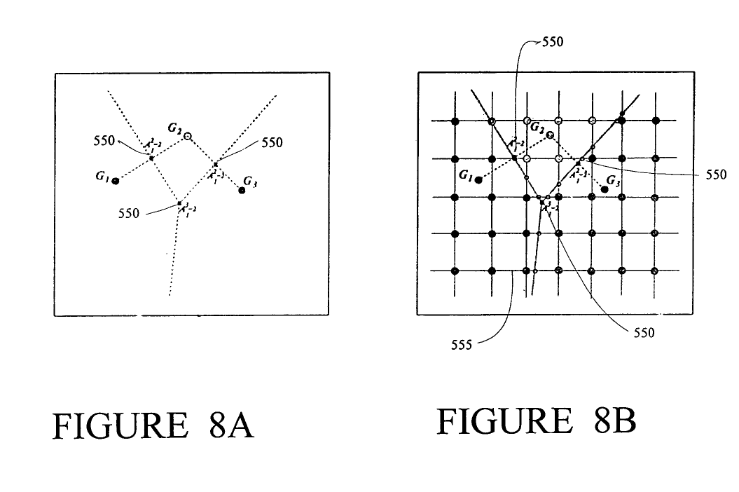

FIGS. 8A and 8B respectively illustrate generally the Lagrangian and the Eulerian methods of shock scaffold computation of the present invention. FIG. 8A is a diagram of Lagrangian computation. Points G₁, G₂, and G₃ are three points of data sampled from the boundary of an object. The method of tracking centers of contact spheres described above with regard to FIG. 5 is computationally intensive, and also not generally practical where the boundary of the object is not already known. Instead, in the present invention, the shock scaffold engine initiates a logical wave at input elements, also referred to as generators, such as points G₁, G₂, and G₃ along the boundary of the object being represented. The waves meet at shock points 550. The shock points are shocks that define shock sheets within the shock scaffold of the object from which the generator points were sampled. In the Lagrangian method, the input elements are paired to create initial shock sources defining sheets representative in the shock scaffold being derived. These shock sources of sheets are then paired to create shock sources for curves. An iterative process of pairing detected sheets and curve shock representatives then permits the construction of the remaining scaffold shock nodes and the connectivity between these.

FIG. 8B is a diagram of the Eulerian computation. In the Eulerian method, input elements such as points G₁, G₂, and G₃ are located with respect to a fixed grid 555. A propagation from each input element, or generator, is then performed on the fixed grid 555. The grid nodes closest to each input element are then labeled accordingly. Elementary cells of the grid where two or more labels arrive at the “same time” are used to compute shocks. The trace of the shock sheets and curves is traced explicitly by computing intercepts with the fixed grid.

In alternative embodiments of either computation method, the input elements are surface patches such as triangles or polygons. Additionally, different types of scanning processes produce different degrees of object surface information. The data having the least amount of information and therefore the greatest degree of difficulty in computing a shock scaffold is the unorganized point cloud. The main cause of computational difficulty is that without a priori knowledge of connectivity between points in the unorganized point cloud, any two points (generators) is a likely pair to create a shock. The computational methods described herein are applied to unorganized point clouds, however, it should be understood that even greater efficiency of shock scaffold derivation can be obtained where more information about data organization is obtained, for example points on the object boundary together with the surface normals at those points.

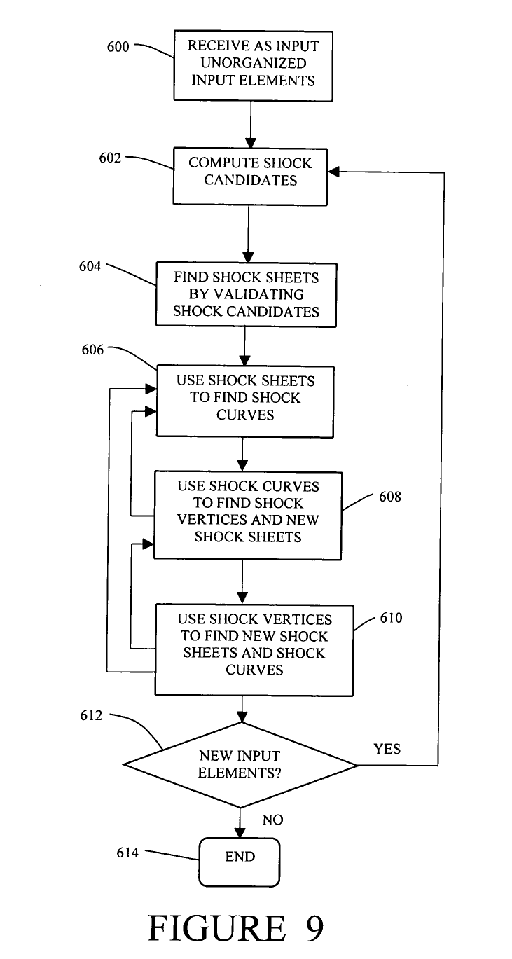

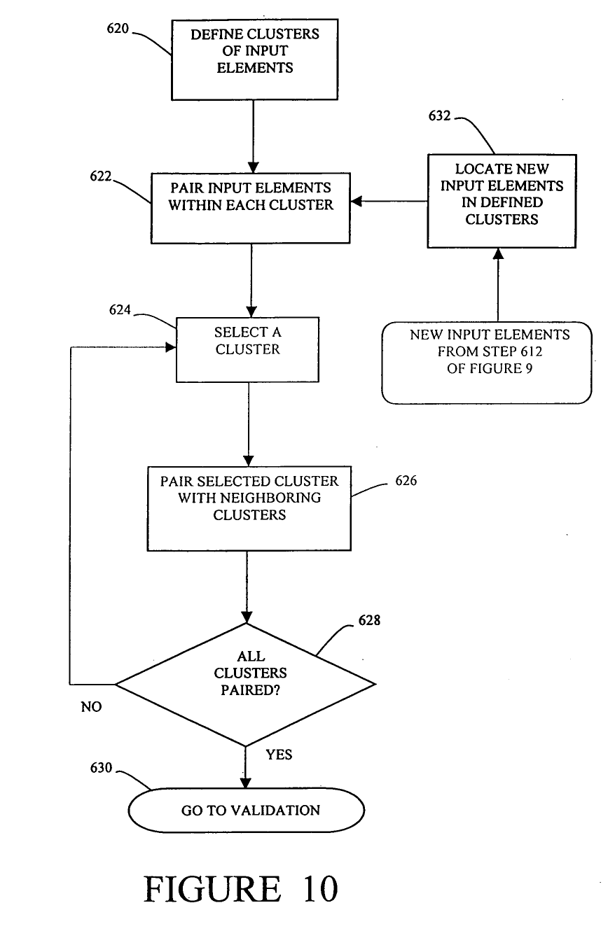

FIG. 9 is a flow chart of a procedure performed by the shock scaffold engine 110 (FIG. 1) when operating in accordance with the Lagrangian computational method for deriving a shock scaffold from an unorganized set of data such as an unorganized point cloud. Given a set of points located in three-dimensional Euclidean space, the first computational method recovers a shock scaffold efficiently by identifying a local network of connectivity between points thereby identifying sources of flow and then by propagating flow to recover the remainder of the shock scaffold.

At step 600, the shock scaffold engine 110 receives as input unorganized input elements such as an unorganized point cloud. In an alternative embodiment of the invention, the unorganized input elements are surface patches of an object.

At step 602, the shock scaffold engine 110 computes shock candidates. In this step, the shock scaffold engine 110 examines the input elements to discover sources of flow, referred to as shock candidates. The shock candidates provide initial points of organization of the shock scaffold.

At step 604, the shock scaffold engine 110 validates the shock candidates as will be described below. The validated shock candidates are shocks that define shock sheets of the shock scaffold.

At step 606, the shock scaffold engine 110 intersects shock sheets to find shock curves. The intersection of a sheet with other sheets that share a common generator creates shock curves. The shock curves are added to the structure of the shock scaffold being derived.

At step 608, the shock scaffold engine 110 uses the shock curves found in step 606 to find shocks vertices and also new shock sheets. The intersection of a curve with other curves sharing two common generators creates new shock vertex candidates. The shock vertices and shock curves are added to the shock scaffold structure being derived. The shock scaffold engine 110 returns to step 606 to find shock curves with the new shock sheets.

At step 610, the shock scaffold engine 110 uses the shock vertices found in step 608 to find new shock sheets and shock curves. The shock scaffold engine 110 returns to step 606 to find further shock curves with the new shock sheets. The shock scaffold engine 110 returns to step 608 to find further shock vertices with the new shock curves.

In an alternative embodiment of the invention, the unorganized input elements at step 600 is an incomplete set of data about the object to be represented by the shock scaffold. An incomplete data set is received as input when, for example, analysis of data from a scanner is performed while scanning continues. At step 612, in the alternative embodiment of the invention, the shock scaffold engine 110 looks for new input elements. If new input elements are received, the shock scaffold engine 110 returns to step 602 to compute new shock candidates from the new input elements. If no new input elements are received the shock scaffold engine 110 proceeds to end the process. This alternative embodiment can be used in dynamic data acquisition scenarios, as described above, and in multi-resolution scenarios, where a subset of the data is first processed, and known remaining data is successively added an processed toward the finest resolution. This method takes advantage of the visibility constraints (described below with respect to FIG. 10) to optimize the search for valid pairs.

At step 614, the process ends when the shock scaffold engine 110 has iterated through all of the shock vertices and there are no more new shock sheets and curves that is, when there are no more shock with unlinked outward flows.

FIG. 10 is a flow chart of a procedure to compute shock candidates performed by the shock scaffold engine 110 (FIG. 1) when operating in accordance with the Lagrangian computational method for deriving a shock scaffold from unorganized input elements, step 602 above. The shock scaffold engine 110 identifies from the unorganized point cloud shocks that are candidates for defining shock sheets.

At step 620, the shock scaffold engine 110 defines clusters of input elements, referred to as generators. In order to efficiently recover a shock scaffold from the generators, the shock scaffold engine 110 imposes a coarse structure on the generators so that the shock scaffold engine 110 has smaller sets of generators to work on and also to better discover local relationships among the generators. There are many ways of imposing a coarse structure on the generators, such as adaptive bucketing. The input elements are defined within Euclidean space and thus are defined in three dimensions having an x direction, a y direction and a z direction. In forming clusters using adaptive bucketing, the shock scaffold first divides the space containing the generators into slabs along the x direction, called x-buckets, where the x-buckets contain approximately equal numbers of generators. In some data samplings, some of the x-buckets will be empty. The shock scaffold 110 then divides the space in each non-empty x-bucket along the y direction to form xy-buckets. The shock scaffold engine 110 forms the xy-buckets such that those xy-buckets containing generators contain approximately equal numbers of generators. Finally, the shock scaffold engine 110 divides the space of each xy-bucket along the z direction into xyz-buckets where the xyz-buckets contain approximately equal numbers of generators.

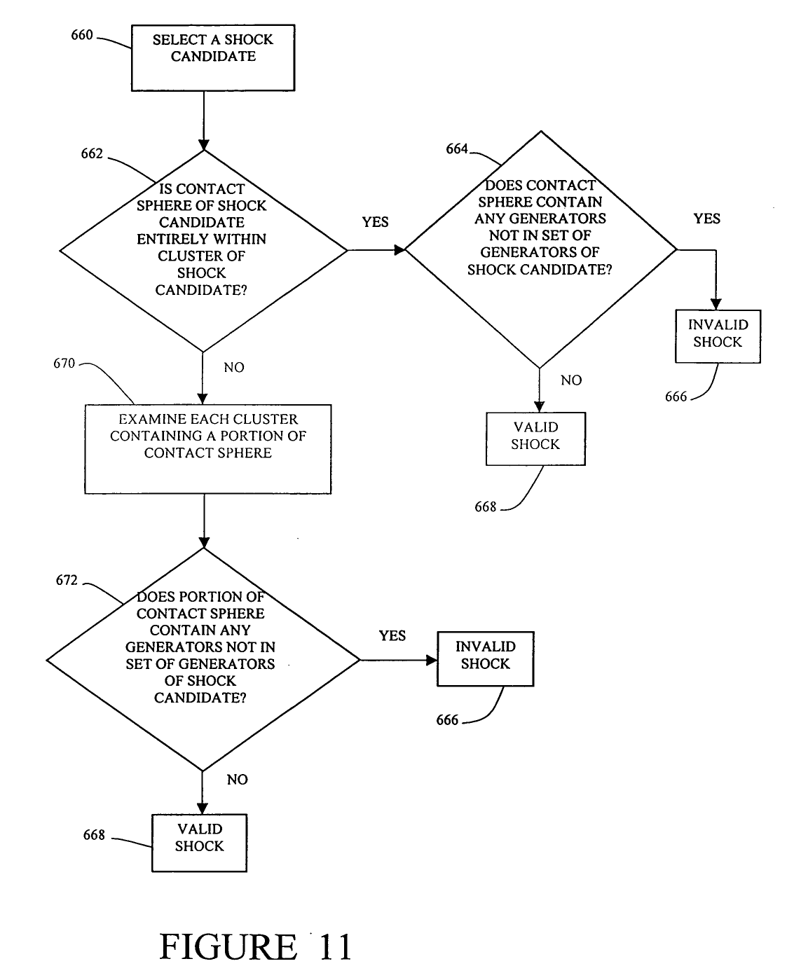

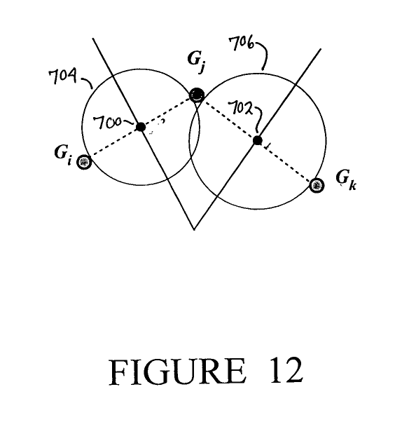

Returning to FIG. 10, at step 622, the shock scaffold engine 110 pairs generators within each cluster. Two generators form a pair of generators if they are visible to each other. Visible means that the two generators could form an A₁² shock source. Generators forming pairs are typically close to each other, that is the generators are neighbors. FIG. 12 is a diagram of visible neighbors. FIG. 12 shows three generators, Gᵢ, Gⱼ, and Gₖ, a first shock 700 and a second shock 702. Generators Gᵢ and Gⱼ are contained in a first maximal sphere 704 and generators Gⱼ and Gₖ are contained in second maximal sphere 706. Gⱼ is visible from Gᵢ, but Gₖ is not. Gᵢ and Gₖ are both visible from Gⱼ. Only Gⱼ is visible from Gₖ. Therefore, Gᵢ and Gₖ cannot be paired to form a maximal sphere defining a shock sheet because the presence of Gₖ does not allow the formation of a maximal sphere with an A₁² shock source. That is, Gⱼ is “in the way.”

Continuing with step 622, the shock scaffold engine 110 selects a generator within a cluster. The shock scaffold engine 110 then tests the selected generator with respect to the other generators within that cluster using visibility constraints. The visibility constraints include finding a closest neighbor to the selected generator. For any generator, its closest neighbor is always a visible neighbor. When the shock scaffold engine 110 finds a generator forming a pair with the selected generator, the shock scaffold engine defines a dead zone. The dead zone is the space behind a tangent plane of the contact sphere containing the selected generator and the paired generator, tangent at the paired generator.

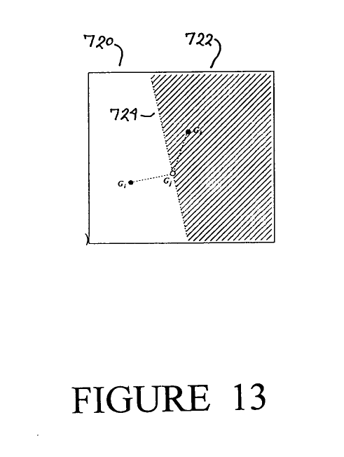

FIG. 13 is a diagram illustrating paired generators and their visible zone 720 and dead zone 722. FIG. 13 shows generators Gᵢ, Gⱼ, and Gₖ of FIG. 12. In this example, generators Gᵢ and Gⱼ are paired. The dead zone 722 is the space behind the tangent plane 724 of Gⱼ, which is “invisible” to Gᵢ and therefore contains no generators with which Gᵢ can be paired. The zone visible to the generator Gᵢ is the space in front of the tangent plane 724. Defining a dead zone quickly eliminates generators from consideration.

When the shock scaffold engine 110 selects a next generator to be tested, the shock scaffold engine 110 first determines whether the generator is located within the dead zone 722 before applying visibility constraints. A test for whether a generator Gk is in the dead zone 722 of generator Gᵢ is by verifying that the following relationship is valid:

(\vec{GᵢGⱼ}, \vec{GᵢGₖ})>(\vec{GᵢGⱼ}, \vec{GᵢGⱼ}) (1)

As generators that pair with the selected generator are found, the dead zone 722 enlarges and the visible zone 720 decreases because dead zones defined by the shock scaffold engine 110 after pairing new generators are additive. In an alternative embodiment of the invention, dead zones resulting from invalid pairings of generators are retained in order to quickly restrict the visible area around the selected generator.

At step 624, after the elements within each cluster are paired, the shock scaffold engine 110 selects a cluster from the defined clusters.

At step 626, the shock scaffold engine 110 pairs the selected cluster with neighboring clusters in a process similar to pairing generators within a cluster. The shock scaffold engine 110 applies visibility constraints and defines dead zone using the clusters as meta-generators. In an alternative embodiment of the invention, each cluster is represented by one or more virtual generators to reduce complexity in applying visibility constraints.

At step 628, the shock scaffold engine 110 determines whether all the clusters have been paired. If not, the shock scaffold engine 110 returns to step 624, and selects another cluster. In another alternative embodiment of the invention, the shock scaffold engine 110 searches for a pair for the selected cluster in a layered spiral around the selected cluster. The shock scaffold engine 110 starts searching for cluster pairs in the closest surrounding clusters to the selected cluster. The shock scaffold engine 110 then visits iteratively other clusters in layers which are increasingly farther away from the selected cluster. Layers are organized as “onion peels” which the shock scaffold engine 110 visits iteratively in a spiraling manner. As the shock scaffold engine examines clusters farther and farther away from the selected cluster, the chances of finding a pair to the selected cluster becomes less and less likely. When the shock scaffold engine 110 finds a cluster that is invisible from the selected cluster, it eliminates new (unvisited) clusters associated with the invisible cluster from the next search layer. This means that the successive layers after the first layer become more fragmented with each iteration.

The set of feasible cluster paths from the selected cluster therefore take the form of a multi-dimensional star shape (2D or 3D) having “arms” that become finer as they grow longer with each iteration layer. Eventually, the arms stop growing because no more clusters are visible or the clusters are exhausted.

At step 628, if all the clusters have been paired, the shock scaffold engine 110 goes to the validation process, step 630, described below with regard to FIG. 11.

In the alternative embodiment of the invention where the initial set of data elements is incomplete, new data elements are added over the course of deriving the shock scaffold, step 612 of FIG. 9. At step 632, the shock scaffold engine 110 locates the new data elements in the defined clusters and proceeds to step 622 where the shock scaffold engine 110 pairs the input elements within each cluster. Such new generators may invalidate previously computed shocks (i.e., make their associated contact sphere non-empty). This effect, however, is only local and can invalidate only shocks of generators which will be paired with the new generators.

FIG. 11 is a flow chart of a procedure to validate shock candidates performed by the shock scaffold engine in accordance with the Lagrangian computational method, step 604 of FIG. 9 and continuing from step 630 of FIG. 10. The generator pairing process described above with regard to FIG. 10 generates shock candidates, that is, shocks that are not necessarily valid. The shock scaffold engine 110 validates the shock candidates in order to derive the shock scaffold. A valid shock candidate has no other generators in its contact sphere other than the pair of generators giving rise to the shock candidate.

At step 660, the shock scaffold engine 110 selects a shock candidate to validate.

At step 662, the shock scaffold engine 110 determines whether the contact sphere of the shock candidate is entirely contained within the defined cluster containing the shock candidate. The defined cluster is one of the clusters defined at step 620 (FIG. 10).

At step 664, if the contact sphere is entirely within the defined cluster, the shock scaffold engine 110 determines whether the contact sphere contains any generators not in the generator pair giving rise to the selected shock candidate.

At step 666, if the shock scaffold engine 110 finds generators other than the generator pair in the contact sphere, the shock scaffold engine 110 defines the selected shock candidate as invalid.

At step 668, if the shock scaffold engine 110 does not find generators other than the generator pair, then the selected shock candidate is valid and the shock scaffold engine 110 adds it to the shock scaffold as node.

At step 670, if the contact sphere is included in clusters in addition to the defined cluster containing the shock candidate, the shock scaffold engine 110 examines each cluster containing a portion of the contact sphere for generators.

At step 672, the shock scaffold engine 110 determines whether the contact sphere contains any generators not in the generator pair giving rise to the selected shock candidate.

At step 666, if the shock scaffold engine 110 finds generators other than the generator pair in the contact sphere, the shock scaffold engine 110 defines the selected shock candidate as invalid.

At step 668, if the shock scaffold engine 110 does not find generators other than the generator pair, then the selected shock candidate is valid and the shock scaffold engine 110 adds it to the shock scaffold as node.

After validation of shock candidates is complete, the shock scaffold engine 110 returns to step 606 to complete the process of deriving the shock scaffold described above with regard to FIG. 9.

In the Eulerian computational method for deriving a shock scaffold, the shock scaffold engine 110 imposes a reference grid on the input elements and simulates wave propagation on the input elements through the reference grid. The reference grid tessellates the space containing the input elements. The logical wavefront is tracked to find a minimum distance to a generator forming a pair with the wavefront initialization generator. In a first embodiment of the Eulerian computational method, the computation is performed on input from a two dimensional object and the grid defines squares. In an alternative embodiment of the invention, the computation is performed on input from a three dimensional object and the grid defines cubes. In further alternative embodiments, other shapes are defined by the grid. Any shapes, including irregular shapes, that join without forming gaps (i.e. that tessellate) may be used for the grid. It should be understood that the method can also be equivalently executed in three dimensions. Waves are simulated by sending beams from an initial grid cell in two dimensions or from an initial chamber in three dimensions.

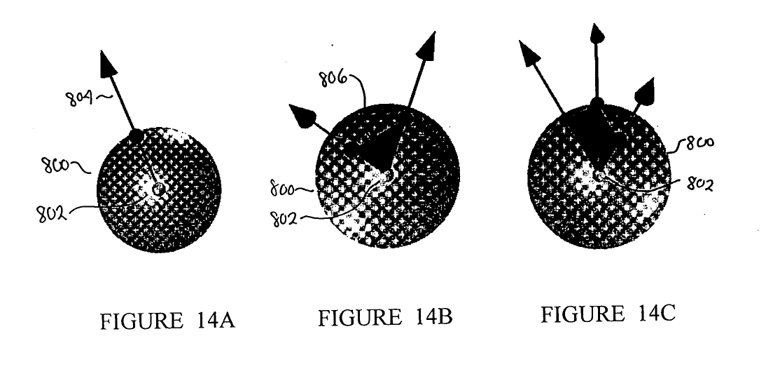

FIG. 14 illustrates the three types of beams. FIGS. 14A, 14B, and 14C each show a sphere having a generator at the center 802. FIG. 14A shows the first type of beam, a one-dimensional (1D) beam 804. The 1D beam 804 propagates along grid directions. FIG. 14B shows the second type of beam, the two-dimensional (2D) beam 806 that propagates as a plane along two grid directions. FIG. 14C shows the third type of beam, the three-dimensional (3D) beam 812 that is formed by combining 2D beams 808, 810 by pair covering orthogonal directions. The 1D beams 804 use paths directly supported by the grid and avoid overlap within the Eulerian grid. 1D beams 804 however do not reach all the cells. 2D beams 806 fill in some of the gaps left by the 1D beams 804 in their planes of propagation. The 3D beams 812 fill in gaps left between the 2D planes of propagation. These beams 804, 806, 812 are referred to as Eulerian automata because they evolve along the grid.

The shock scaffold engine 110 uses generators as sources of beam propagation and where the beams collide, shocks are formed. Each successive cell along the beam path is labeled with the label of the initiating generator and the signed distance vector from the generator. Essentially, the shock scaffold engine 110 derives a shock scaffold from input elements by initiating all types of beams from all possible generators in the input data set.

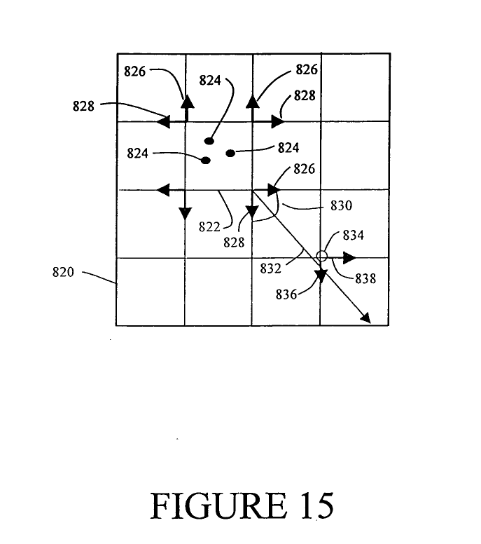

FIG. 15 is a two dimensional grid showing beam propagation using the Eulerian computational method of deriving a shock scaffold. Beam propagation is shown in two dimensions for simplicity. The 3D beam is similarly propagated through the grid. The two dimensional reference grid 820 has a plurality of cells, one cell 822 having three generators 824. Vertical 1D beams 826 and horizontal 1D beams 828 propagate from each corner of the cell 822. A 2D beam 830 propagates from one corner of the cell in a direction indicated by the arrow 832. Where the beam 830 passes through a node 834 of another cell, more 1D beams 836, 838 are initialized.

The shock scaffold generator 110 propagates logical waves through the grid by initializing beams 826, 828, and 830 at the cell 822 containing at least one generator 824. The logical waves propagate through the fixed grid 820 initializing more beams 836, 838 that carry generator and distance information in a vector. Eventually, propagating beams in the fixed grid collide forming a shock.

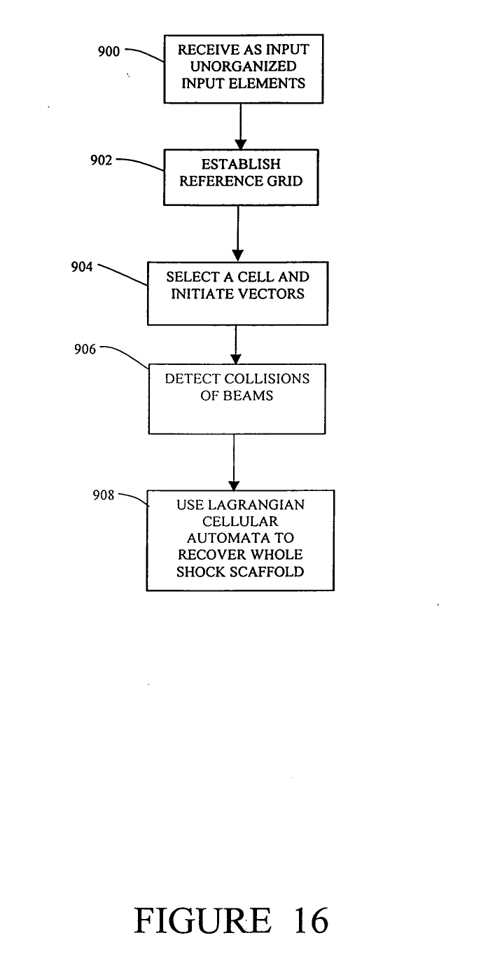

FIG. 16 is a flow chart of a procedure that is performed by the shock scaffold engine 110 (FIG. 1) when operating in accordance with the Eulerian computational method of generating a shock scaffold.

At step 900, the shock scaffold engine 110 receives as input unorganized input elements such as an unorganized point cloud as described above for the first computational method.

At step 902, the shock scaffold engine 110 establishes a reference grid around the input elements. For a two-dimensional (2D) object, the shock scaffold engine defines a two-dimensional reference grid. For a three-dimensional (3D) object, the shock scaffold engine defines a three-dimensional reference grid. Each cell (in 2D) or each chamber (in 3D) of the grid contains zero or more input elements, or generators.

At step 904, the shock scaffold engine 110 selects a cell (or a chamber) and initiates vectors (that is 1D beams) along the grid in a subset of possible directions of flow from the input elements contained in the cell. The vectors define cellular automata. Each vector on the grid is a cellular automaton. A cellular automaton is an entity in an n-dimensional grid that carries information. Each cell in the grid has a discrete state. The cellular automata follow rules that describe the state of the cell for the next step depending on the states of the cells in the neighborhood of the cell. In the present invention, cellular automata carry information about its generator and a distance from the generator. Each input from a cell along a propagation path carries information away from the initial generator and into the grid. 1D cellular automata (that is 1D beams) move but typically are not able to cover all grid points. The shock scaffold generator 110 combines 1D beams into 2D beams and also 1D and 2D beams into 3D beams (also referred to as cones) that are able to propagate fully through the grid. The shock scaffold engine 110 continues to select cells and initiate beams until all the generators in the input data have been used to initiate beams.

At step 906, the shock scaffold engine 110 detects shocks wherever beams (or cellular automata) collide in the grid. Because beams are initiated at all generators in the input data, beams are propagated in many different directions in the grid and therefore at least some of the beams are bound to collide. A collision forms a shock which is part of the shock scaffold being derived from the unorganized input elements by the shock scaffold engine 110.

At step 908, the shock scaffold engine 110 uses a Lagrangian method for finding shock sheets and shock curves of the shock scaffold.

To trace shock waves for planar sheets and curves once the shock scaffold engine 110 detects shock sources there are two additional classes of automata to propagate through the grid. The two additional classes of cellular automata are referred to as Lagrangian because they evolve away from the reference grid. The first additional class of automata is a 2D class of automata moving along intercepts with chambers'edges and the second class of automata is a 1D class of automata moving along straight lines, keeping record of their intercepts with chambers'faces.

Lagrangian cellular automaton for shock sheets, which, once initiated from a shock source, grows a planar sheet radially around that shock source. This 2D growth is obtained by computing intercepts of the sheet with chambers'edges. A 1D Lagrangian cellular automaton for shock curves, which, once initiated from an shock source, grows a straight curve in one or two opposite directions from that shock source. The 1D growth is obtained by computing intercepts of the curve with chambers'faces .

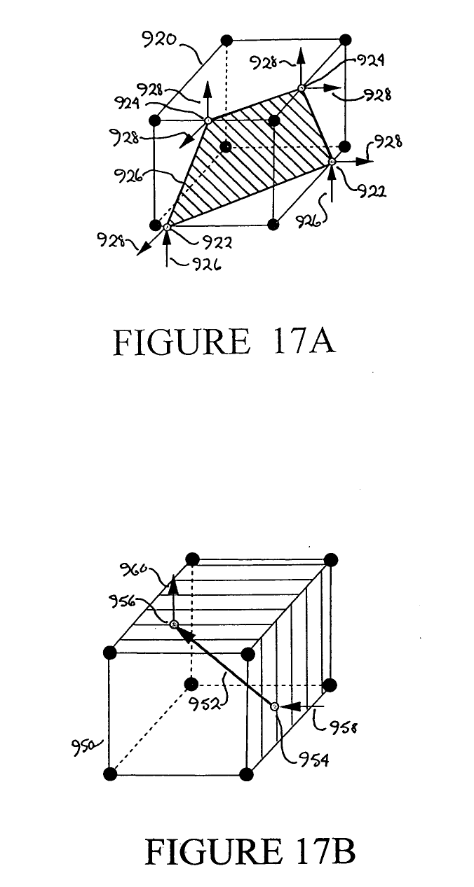

FIG. 17A is a diagram of a grid chamber 920 illustrating passage of the first type of Lagrangian cellular automata, the 2D Lagrangian automata for shock sheets. The grid chamber 920 is one chamber in a larger reference grid. In this example, a shock sheet 926 enters the grid chamber 920 from the bottom at a pair of edge intercepts 922, propagates through the grid chamber 920 and intercepts at the top via two more edge intercepts 924. Inward flows to the grid chamber 920 are indicated via arrows 926 at the edge intercepts 922. Outward flows to surrounding chambers are indicated via arrows 928 at the edge intercepts 922, 924. The outward flows are used to propagate further the Lagrangian cellular automata for shock sheets.

FIG. 17B is a diagram of a grid chamber 950 illustrating passage of the second type of Lagrangian cellular automata, the 1D Lagrangian automata for shock curves. The grid chamber 950 is one chamber in a larger reference grid. In this example, a shock curve 952 enters the chamber from the right at a first face intercept 954 and leaves it from the top at a second face intercept 956. The shock curve 952 at the first intercept 954 has an inward flow into the grid chamber 952 indicated by arrow 958. The shock curve 952 at the second intercept 956 has an outward flow indicated by arrow 960. The outward flow propagates the 1D Lagrangian automaton for the shock curve 952 to other chambers in the grid.

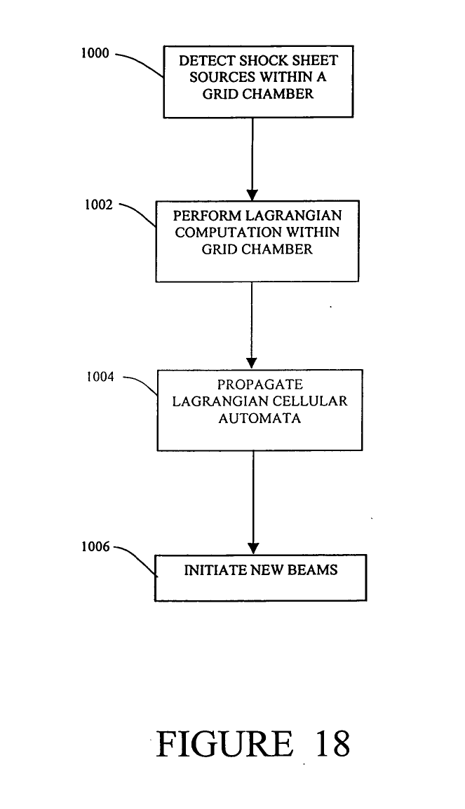

FIG. 18 is a flow chart of the operation of shock scaffold engine 110 using the Lagrangian cellular automata to recover the shock sheets and shock curves of a shock scaffold, during step 908 of FIG. 16. In general, the shock scaffold engine 110 traces shock waves (or logical wavefronts) by following “particles” and their intercepts with the fixed grid, also referred to as the Eulerian grid. The connectivity amongst these intercepts is then called a Lagrangian grid, tracing the flow of the particles in space. The shock scaffold engine 110 processes the Lagrangian automata in a grid chamber after the Eulerian wavefronts have passed entirely through the chamber. Then, for each chamber, the shock scaffold engine performs the Lagrangian automata computations related to that chamber.

At step 1000, the shock scaffold engine 110 detects shock sheet sources within a selected grid chamber. The shock scaffold engine 110 collects all generator labels present at the eight vertices of the chamber. The shock scaffold engine 110 then detects the shock sheets sources by determining shock candidates whose contact sphere is located within the chamber's limits. The shock scaffold engine validates shock sheet candidates for those generators whose logical wavefronts have reached the selected grid chamber.

At step 1002, the shock scaffold engine 110 performs a local iterative shock flow of sheets and curves within the chamber's limits. In this step, the shock scaffold engine 110 iteratively intersects sheets to detect new shocks curves, and iteratively intersects shock curves to detect new shocks until all flows in the chamber are exhausted as described above in step 608 and 610 of FIG. 9. In essence, the shock scaffold engine 110 performs a mini-Lagrangian shock scaffold computation (the first computational method described above) at the chamber scale. The shock scaffold engine 110 performs the local Lagrangian shock scaffold computation for all chambers containing shocks.

At step 1004, the shock scaffold engine 110 propagates the Lagrangian cellular automata to other chambers and initiate new Lagrangian cellular automata from newly detected shocks. The shock scaffold engine 110 propagates the Lagrangian cellular automata by computing their new intercepts at the chamber's edges and faces, and by validating the intercepts.

At step 1006, the shock scaffold engine 110 initiates new beams at the eight chambers bounding the selected grid chamber, if necessary. The shock scaffold engine 110 verifies if the new beams'intercepts can minimize distance vectors, d, associated to the selected grid chamber's vertices. If a new beam does reset a minimum distance vector (that is, the beam does not collide with another), then the shock scaffold engine 110 initiates a new beam to propagate further a generator label and distance function, thereby producing an exact distance map.

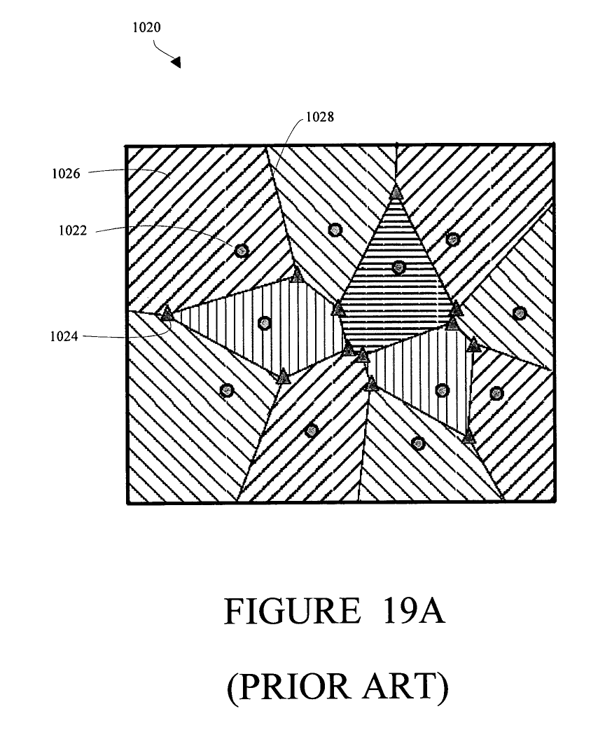

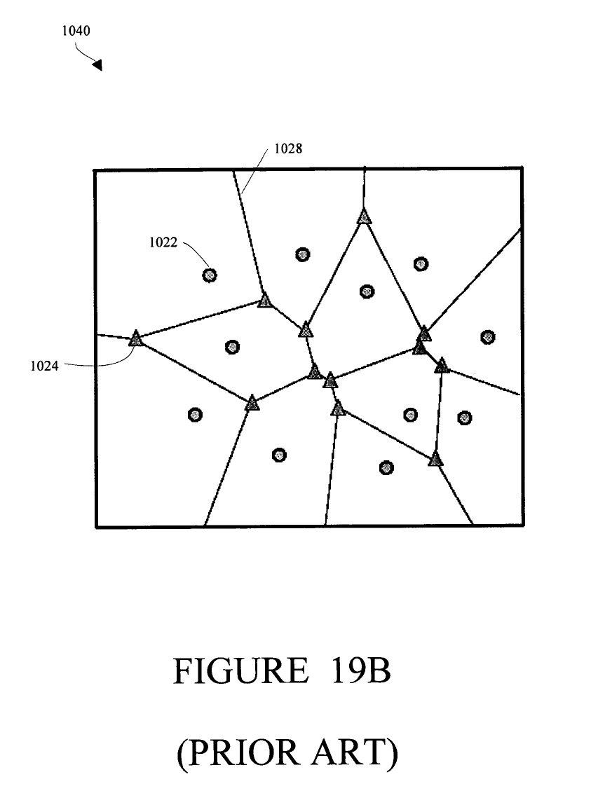

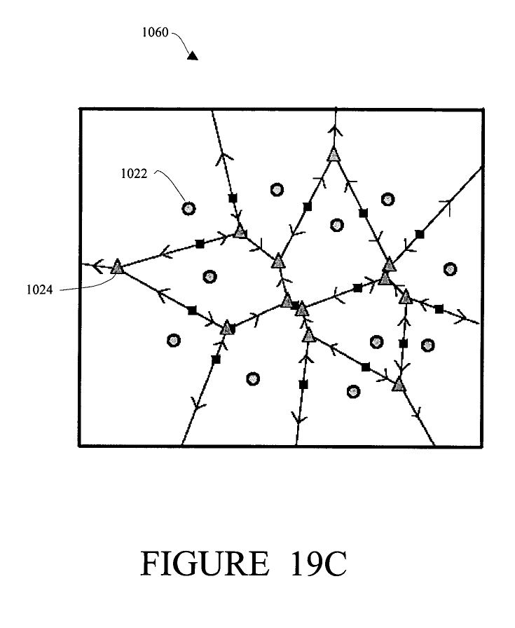

In alternative embodiments of the invention, other types of data input can be used to build shock scaffold representations of objects. For example, a Voronoi diagram input can be used. FIG. 19A is an example of a Voronoi diagram 1020 for a set of eleven point generators 1022. FIG. 19B is a medial axis 1040 for the set of point generators 1022 of FIG. 19A. FIG. 19C is the shock scaffold 1060 for the point generators 1022 of FIG. 19A. FIGS. 19A, 19B and 19C each show a plurality of sampled points, the set of point generators 1022, taken from an object surface. Each point 1022 is contained in a Voronoi region 1026 defined by Voronoi vertices 1024 (also referred to as shock vertices) and Voronoi edges 1028. A Voronoi diagram 1020 is a decomposition of space into ownerships by the points 1022. The Voronoi diagram 1020 establishes neighborhoods by indicating space associated with each point 1022 with the boundaries 1024. The Voronoi diagram 1020 when used as input to the shock scaffold engine 110 indicates which points 1022 are neighbors and therefore provides rudimentary information for finding shock candidates. In an alternative embodiment of the Voronoi diagram 1020, curve segments or surface patches are used instead of points.

As can be seen in FIG. 19C, a Voronoi graph is included in the shock scaffold 1060. Therefore, the shock scaffold of an object surface, for example, can be used to compute the Voronoi diagram of the object surface. In addition, other subsets of the shock scaffold can be used to compute other important graphs. For example, a set of shock sources for sheets obtained in a first phase of the Lagrangian method indicate all the pairs that can be linked by Delaunay edges. A Delaunay edge is an edge such that a sphere with a diameter defined by the edge linking a pair of generators is empty of other generators. Delaunay edges are a subset of a Delaunay mesh which is a dual to the boundaries of the Voronoi diagram. Thus, a shock scaffold calculation can be used to determine a Delaunay mesh.

A Gabriel graph in three dimensions is obtained by considering a set of shock curve sources obtained by pairing shock sheets without the need to consider shock vertices. A Gabriel graph is a collection of (N-1-D) simplices showing connectivity. In a three-dimensional case, a simplex is a triangle. Each simplex, for example, each triangle, must be such that the sphere passing through the points defining the simplex is empty of other generators. That is, the sphere passing through the three points defining the triangle is empty of other generators. The sphere is associated with the sources of shock curves. Accordingly, the Lagrangian computational method described above can be used to find the sphere. Accordingly, the shock scaffold computation can be used to find a Gabriel graph directly whereas other method of finding the Gabriel graph, such as the Voronoi diagram and Delaunay tessellations are indirect methods. The Voronoi diagram and Delaunay tessellations both require a larger structure to be computed and then searched to find the Gabriel graph as a subset.

It is to be understood that the above-described embodiments are simply illustrative of the principles of the invention. Various and other modifications and changes may be made by those skilled in the art which will embody the principles of the invention and fall within the spirit and scope thereof.

What is claimed is:

1. A method for representing a multidimensional shape, comprising the steps of:
receiving as input a plurality of points in space;
forming a plurality of shocks based on said plurality of points by initiating a plurality of wavefronts at selected points of said plurality where shocks are formed at collisions of said plurality of wavefronts, said plurality of shocks holding topology information about the multidimensional shape, said topology information including flow speed and accelerations and direction from boundaries of said multidimensional shape; and
generating a shock scaffold from said plurality of shocks, said shock scaffold representing the multidimensional shape where the multidimensional shape is capable of being reconstructed from said shock scaffold.

2. The method of claim 1 wherein said step of forming the plurality of shocks further comprises the steps of:
(a) defining a plurality of clusters within said plurality of points where each point of said plurality of points belongs to one of said plurality of clusters;
(b) examining each cluster to determine pairs of generators based on visibility constraints between points;
(c) generating a shock candidate from each of said pairs of generators;
(d) for each shock candidate,
(i) forming a contact sphere; and
(ii) examining said contact sphere to find whether said contact sphere is contained within a cluster with said shock candidate,
(1) when said contact sphere is contained with a cluster with said shock candidate, then validating each shock candidate by examining said contact sphere and its generators within said cluster where said shock candidate is validated as a shock if no generating points other than its generators are included in said contact sphere,
(2) when said contact sphere is not contained with a cluster with said shock candidate, then validating each shock candidate by examining said contact sphere and its generators within said cluster and generators in neighboring clusters also containing said contact sphere where said shock candidate is validated as a shock if no generating points other than its generators are included in said contact sphere,
whereby a plurality of shocks is created from validated shock candidates, each shock holding topology information about the multidimensional shape derived from said generators.

3. The method of claim 2 wherein the step of generating a plurality of shock candidates further comprises the steps of:
generating a first wavefront from one generator of each said pair;
generating a second wavefront from a second generator of each pair; and
determining a shock candidate from a collision point and flow direction at a collision of said first wavefront and said second wavefront.

4. The method of claim 2 further comprising the step of determining pairs of clusters after said step of determining pairs of generators, said pairs of clusters determined based on visibility constraints between clusters, said paired clusters reducing an amount of clusters to be examined in validating shock candidates.

5. The method of claim 2 further comprising the step of dynamically adding new points to said plurality of points and repeating steps b-d for each said new point.

6. The method of claim 2 wherein said shocks are A₁² shocks describing shock sheets associated with said multidimensional shape.

7. The method of claim 1 wherein said step of generating a shock scaffold further comprises the steps of:
generating shock curves from said shocks; and
generating a set of shock vertices of said shock scaffold from said shock curves.

8. The method of claim 1 further comprising the step of receiving connectivity information for said plurality of points in a Voronoi diagram of said plurality of points; and said step of forming a plurality of shocks is further based on said Voronoi diagram.

9. The method of claim 1 further comprising the step of computing a Voronoi diagram from said shock scaffold.

10. The method of claim 1 wherein said step of determining a plurality of shocks further comprises the steps of:
defining a fixed multi-dimensional grid in space around said plurality of points, said multi-dimensional grid including a plurality of chambers;
initiating cellular automata along said grid in a subset of possible directions from a first chamber including a first point of said plurality of points and from a second chamber including a second point of said plurality of points;
propagating said cellular automata through said grid outward from said first and said second chambers until each said cellular automaton collides with another cellular automaton; and,
determining a shock at each collision.

11. The method of claim 10 wherein at least one of said cellular automata is a three-dimensional beam.

12. The method of claim 11 wherein said three-dimensional beam is formed by pairing two two-dimensional beams covering orthogonal orientations of said grid.

13. The method of claim 10 wherein said chambers are irregularly-shaped tessellating chambers.

14. The method of claim 10 further comprising the steps of:
detecting sheet source shocks in each said chamber;
generating shock curves from said shocks in each said chamber;
generating a set of shock vertices of said shock scaffold from said shock curves in each said chamber;
propagating existing cellular automata in each said chamber;
initiating first new cellular automata from said sheet source shocks; and
initiating second new cellular automata from vertices of each said chamber in response to changes at said vertices caused by said first new cellular automata.

15. A method for representing a multidimensional shape, comprising the steps of:
receiving as input a plurality of polygons in space;
determining pairs of generator polygons based on visibility constraints between polygons in said plurality;
generating a first plurality of wavefronts from a first generator polygon in each pair;
generating a second plurality of wavefronts from a second generator polygon in each pair, where said pluralities of wavefronts include planar wavefronts from planes of said first and said second generator polygons, spherical wavefronts from said vertices of said first and said second generator polygons, and cylindrical wavefronts from edges of said first and said second generator polygons;
determining shocks from collisions of said first plurality of wavefronts and said second plurality of wavefronts; and
generating a shock scaffold representing said multidimensional shape from said plurality of shocks where the multidimensional shape can be reconstructed from the shock scaffold.

16. A shock scaffold for representing a multidimensional shape, comprising:
a plurality of shocks, each shock holding topology information about the multidimensional shape by storing position information from a plurality of generator points related to the surface of the multidimensional shape and flow direction of the surface of the multidimensional shape;
a plurality of implicit curve segments connecting said plurality of shocks; and
a plurality of implicit shock sheets described by said plurality of implicit curve segments,
wherein said plurality of shocks, said plurality of implicit curve segments, and said implicit shock sheets form a directed graph that is a representation of the multidimensional shape where the multidimensional shape can be reconstructed from the information contained in the shock scaffold.

17. The shock scaffold of claim 16 wherein each said plurality of shocks is qualified according to a number of contact points of with the multidimensional shape by a maximal sphere centered at said shock.

18. The shock scaffold of claim 16 wherein each said plurality of shocks is qualified according to a degree of contact with the multidimensional shape of a maximal sphere centered at said shock.

19. The shock scaffold of claim 16 wherein each said plurality of shocks is classed as one of a plurality of classes: (a) regular if said shock is a point at which flow is smooth, (b) source if said shock initiates flow, (c) sink if said shock terminates flow, and (d) relay if said shock is a source of flow and a termination for flow, said plurality of classes providing topology information about the multidimensional shape.

20. A system for representing a multidimensional shape, comprising:
a memory;
an interface which is configured to receive a plurality of sample points corresponding to the multidimensional shape; and
a controller coupled to said memory and said interface, said controller being configured to
(i) generate a shock scaffold to represent the multidimensional shape based on said plurality of sample points, and
(ii) store said shock scaffold in said memory, wherein said shock scaffold includes nodes defined as critical points of flow speed and direction of surface boundaries of said multidimensional shape.

21. The system of claim 20 wherein said controller includes:
circuitry which is configured to generate said shock scaffold based on said plurality of sample points and point clustering precepts and visibility constraints.

22. The system of claim 20 wherein said controller includes:
circuitry which is configured to generate said shock scaffold using wavefront propagation on a multidimensional grid, wavefronts of said wavefront propagation generated in response to said plurality of sample points.

23. The system of claim 20 wherein said controller includes:
circuitry which is configured to derive multiple sub-graphs from said shock scaffold, at least one of said multiple sub-graphs relating to a boundary of said multidimensional shape.
